(19) United States
(12) Patent Application Publication
(10) Pub. No.: US 2021/0022203 A1
(43) Pub. Date: Jan. 21, 2021

(54) METHOD FOR DEACTIVATING USER PLANE CONNECTION AND NETWORK ENTITY FOR CONTROLLING USER PLANE CONNECTION DEACTIVATION IN NETWORK

(71) Applicant: ELECTRONICS AND TELECOMMUNICATIONS RESEARCH INSTITUTE, Daejeon (KR)

(72) Inventors: Yoo Hwa KANG, Daejeon (KR); Changki KIM, Daejeon (KR)

(21) Appl. No.: 16/929,841

(22) Filed: Jul. 15, 2020

(30) Foreign Application Priority Data
Jul. 17, 2019 (KR) 10-2019-0086260
Jul. 10, 2020 (KR) 10-2020-0085100

(51) Int. Cl. H04W 76/30; H04W 8/08; H04W 48/16; H04W 24/10

(52) U.S. Cl. CPC H04W 76/30; H04W 24/10; H04W 48/16; H04W 8/08

(57) ABSTRACT

A method for deactivating a UP connection (User Plane connection) in a network and a network entity for controlling UP connection deactivation in a network. The method may include: when a multi access Packet Data Unit session (MA PDU session) is established through a multi access network, determining, by a Session Management Function (SMF), to deactivate a UP connection for a first access network from the multi access network; and sending, by the SMF, a message instructing an Access and Mobility Management Function (AMF) to deactivate the UP connection for the first access network to the AMF.

### CROSS-REFERENCE TO RELATED APPLICATION

This application claims priority to and the benefit of Korean Patent Application Nos. 10-2019-0086260 and 10-2020-0085100 filed in the Korean Intellectual Property Office on Jul. 17, 2019 and Jul. 10, 2020, respectively, the entire contents of which are incorporated herein by reference.

### BACKGROUND OF THE INVENTION

### 1. Field of the Invention

The present invention relates to a method for deactivating a UP connection (User Plane connection) in a network and a network entity for controlling UP connection deactivation in a network.

### 2. Description of Related Art

Recently, standardization of 5G network technology has been underway. In this 5G network, the standardization work is underway to support access traffic steering, switching, and splitting (ATSSS) between a 3GPP access network and a non-3GPP access network.

Traffic steering is the procedure that selects an access network for a new data flow and transfers the traffic of this data flow over the selected access network. Traffic switching is the procedure that moves all traffic of an ongoing data flow from one access network to another access network in a way that maintains the continuity of the data flow. Traffic splitting is the procedure that splits the traffic of a data flow across multiple access networks. When traffic splitting is applied to a data flow, some traffic of the data flow is transferred via one access and some other traffic of the same data flow is transferred via another access.

In order to provide traffic (data, voice, etc.) to user equipment (UE) in a 5G network, Packet Data Unit (PDU) session establishment is required between the UE and a data network. Existing PDU session establishment is performed only through the UE and one access network (3GPP access network or non-3GPP access network), thereby establishing a Single Access PDU (SA PDU) session. A plurality of SA PDU sessions may be established in one UE, and the plurality of SA PDU sessions may be distinguished through PDU session identifiers, respectively.

However, since an existing Single Access PDU (SA PDU) session is established to only one access network, user traffic belonging to the corresponding PDU session may not be transmitted/received through two or more access networks. Accordingly, it is difficult to provide a service supporting the ATSSS function. To support the ATSSS function, one PDU session with unique identifier established over two or more accesses is required. This PDU session is called a Multi Access PDU (MA PDU) session.

On the other hand, when it is necessary to deactivate a UP connection to save radio and network resources in a 5G network, it is difficult to control the deactivation of one or more UP connections in a MA PDU session established through a multi access network by using the UP connection deactivation method for a PDU session established through a single access network.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention provides a method for deactivating a UP connection in a network and a network entity for controlling UP connection deactivation in a network, capable of deactivating UP connections for each access within a MA PDU session established through a multi access network.

According to an exemplary embodiment of the present invention, a method for deactivating a UP connection (User Plane connection) in a network is provided. The method includes: when a multi access Packet Data Unit session (MA PDU session) is established through a multi access network, determining, by a Session Management Function (SMF), to deactivate a UP connection for a first access network from the multi access network; and sending, by the SMF, a message instructing an Access and Mobility Management Function (AMF) to deactivate the UP connection for the first access network to the AMF.

The sending, by the SMF, the message to the AMF may include: sending, by the SMF, a message having an access type corresponding to the UP connection determined to be deactivated, and the access type includes at least one of a 3GPP access network and a non-3GPP access network.

The message may include a Namf_Communication_N1N2MessageTransfer message.

The method may further include: receiving, by the SMF, a Nsmf_PDUSession_UpdateSMContext message from the AMF in response to the Namf_Communication_N1N2MessageTransfer message.

The determining, by the SMF, to deactivate the UP connection for the first access network may include: when it is determined that the UP connection for the first access network is unavailable based on a Performance Measurement Function (PMF) access report, determining, by the SMF, to deactivate the UP connection for the first access network.

The determining, by the SMF. to deactivate the UP connection for the first access network may include: when no data transfer occurs through the UP connection for the first access network for a preset time, determining, by the SMF, to deactivate the UP connection for the first access network.

The method may further include: determining, by the SMF, to release an N3 terminating User Plane Function (UPF); and sending, by the SMF, an N4 Session Release Request message to the N3 terminating UPF.

The method may further include: sending, by the SMF, an N4 Session Modification Request message having access information to another UPF connected to the N3 terminating UPF.

The method may further include: determining, by the SMF, not to release an N3 terminating UPF; and sending, by, the SMF, an N4 Session Modification Request message having access information to the N3 terminating UPF.

According to another exemplary embodiment of the present invention, a method for deactivating a UP connection in a network is provided. The method includes: for a MA PDU session established through a multi access network, when it is determined to deactivate a UP connection for a first access network from the multi access network, receiving, by an AMF, a message instructing the AMF to deactivate the UP connection for the first access network from a SMF; and releasing, by the AMF, resources for the first access network.

The receiving, by the AMF, the message from the SMF may include: receiving, by the AMF, a message having an access type corresponding to the UP connection determined to be deactivated from the SMF, and the access type comprises at least one of a 3GPP access network and a non-3GPP access network.

The message may include a Namf_Communication_N1N2MessageTransfer message.

The releasing, by the AMF, the resources for the first access network may include: sending, by the AMF, an N2 PDU Session Resource Release Command message to the first access network.

The method may further include: receiving, by the AMF, an N2 PDU Session Resource Release Response message from the first access network.

The method may further include: sending, by the AMF, a Nsmf_PDUSession_UpdateSMContext message to the SMF.

The receiving, by the AMF, the message from the SMF may include: when it is determined that the UP connection for the first access network is unavailable based on a PMF access report, receiving, by the AMF, the message instructing the AMF to deactivate the UP connection for the first access network from the SMF.

The receiving, by the AMF, the message from the SMF may include: when no data transfer occurs through the UP connection for the first access network for a preset time, receiving, by the AMF, the message instructing the AMF to deactivate the UP connection for the first access network from the SMF.

According to another exemplary embodiment of the present invention, a network entity for controlling a UP connection deactivation in the network is provided. The network entity includes: a processor configured to, when a MA PDU session is established in an user equipment, control to deactivate a UP connection of the MA PDU session; and a network interface configured to send at least one of an N4 Session Release Request message, an N4 Session Modification Request message, and a Namf_Communication_N1N2MessageTransfer message having an access type corresponding to the UP connection determined to be deactivated, to another network entity, wherein the processor deactivates the UP connection for the access network corresponding to the access type.

The network interface may send the N4 Session Release Request message or the N4 Session Modification Request message to the N3 terminating UPF through an N4 interface.

The network interface may send the Namf_Communication_N1N2MessageTransfer message to the AMP through an N11 interface.

According to embodiments of the present invention, the UP connection can be deactivated for each access within a MA PDU session established through a multi access network. By controlling the UP connection for each access as described above, not only can the ATSSS function be supported smoothly, but also the wireless and network UP resource saving can be effectively achieved.

### BRIEF DESCRIPTION OF THE DRAWINGS

FIG. 1 is a diagram illustrating a 5G network according to an embodiment of the present invention.

FIG. 2 is a conceptual diagram of a MA PDU session for supporting the ATSSS function according to an embodiment of the present invention.

FIG. 3 is a flowchart illustrating a method for deactivating a UP connection according to an embodiment of the present invention.

FIG. 4 is a flowchart illustrating a method for deactivating a UP connection according to another embodiment of the present invention.

FIG. 5 is a diagram illustrating a computing system according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification, user equipment (UE) may indicate a terminal, a mobile terminal (MT), a mobile station (MS), an advanced mobile station (AMS), a high reliability mobile station (HRMS), a subscriber station (SS), a portable subscriber station (PSS), an access terminal (AT), or the like, and may include all or some of the functions of the terminal, the MT, the AMS, the HR-MS, the SS, the PSS, the AT, or the like.

In addition, a base station (BS) may indicate an advanced base station (ABS), a high reliability base station (HR-BS), a nodeB, an evolved nodeB (eNodeB), a base transceiver station (BTS), a mobile multihop relay (MMR)-BS, a relay station (RS) serving as a base station, a high reliability relay station (HR-RS) serving as a base station, and the like, and may include all or some of the functions of the BS, the ABS, the nodeB, the eNodeB, the BTS, the MMR-BS, the RS, the HR-RS, and the like.

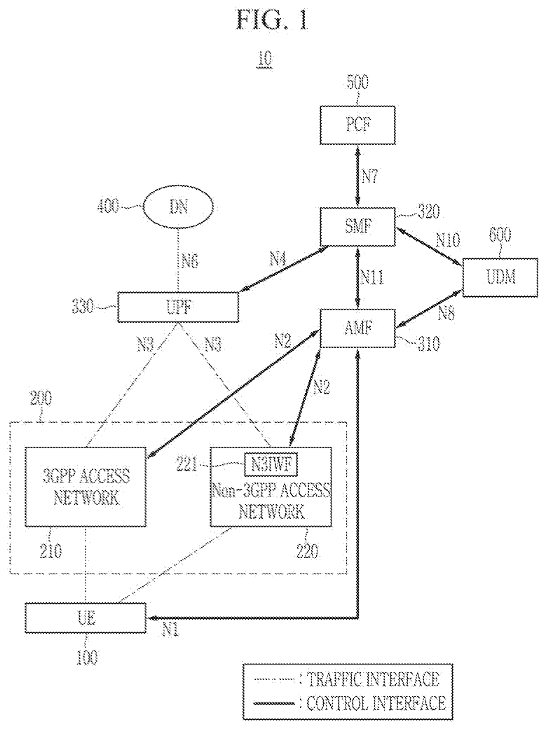

FIG. 1 is a diagram illustrating a 5G network according to an embodiment of the present invention.

As shown in FIG. 1, a 5G network 10 according to an embodiment of the present invention may include user equipment (UE) 100, an access network (AN) 200, an Access and Mobility Management Function (AMF) 310, a Session Management Function (SMF) 320, a User Plane Function (UPF) 330, a data network (DN) 400, a policy control function (PCF) 500, and a unified data management (UDM) 600.

The UE 100 may access a network through the AN 200. The AN 200 may include a 3GPP access network 210 and a non-3GPP access network 220. The UE 100 may access a mobile radio access network via the 3GPP access network 210. The UE 100 may access a wireless LAN access network via the non-3GPP access network 220. The non-3GPP access network 220 may include a non-3GPP interworking function (N3IWF) 221 for the N3 and N2 interfaces with the UPF 330 and the AMF 310 by a 5G core network common interface principle.

The AMF 310 and the SMF 320 are network entities that process control signals. The AMF 310 performs authentication, connection, and mobility control functions. The SMF 320 has a session control function (establishment/modification/release for a session), and performs a signaling procedure for traffic path establishment and traffic mobility management. That is, the SMF 320 controls a data path between the UFF 330 and the AN 200. The AMF 310 has a non-access stratum (NAS) signal interface N1 together with the UE 100.

The UPF 330 is a network entity of a data plane that accommodates the multiple access networks 210 and 220 via common N3 interface. The UFF 330 connects a data plane between the multiple access networks 210 and 220 and the ON 400 so that traffic of the UE 100 (i.e., the user) can be transmitted and received.

The UFF 330 and the access network 200 receive control rules for traffic between the UE 100 and the UPF 330 via N4 and N2 interfaces from the SMF 320, respectively, and perform functions such as traffic detection, routing, and QoS control using the received control rues.

The PCF 500 is connected to the SMF 320 through an N7 signal interface, and controls policies related to session, mobility, and QoS. The PCF 500 may transmit Policy and Charging Control (FCC) rules required for the SMF 320 to map into (a) ATSSS rules to the SMF 320.

The UDM 600 is connected to the SMF 320 through an N10 signal interface, and manages user information management and policy for each UE such as subscription information of the UE 100. The UDM 600 may transmit information about the profile and subscription of the UE 100 to the SMF 320 for ATSSS function. hi addition, the UDM 600 is connected to the AMF 310 through an N8 signal interface to exchange information.

As described above, the 5G network system according to an exemplary embodiment of the present invention is an integrated structure that simultaneously accommodates the 3GPP access network 210 and the non-3GPP access network 220. In order to provide the ATSSS function in such an integrated structure, a procedure for establishing a Multi Access PDU (MA PDU) session and a procedure for deactivating a UP connection (User Plane connection) on the established MA PDU session are required.

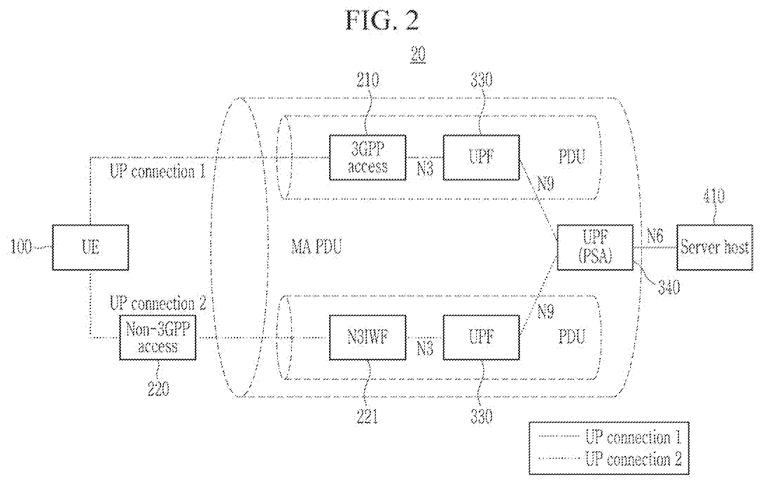

FIG. 2 is a conceptual diagram of a MA PDU session for supporting the ATSSS function according to an embodiment of the present invention.

Referring to FIG. 2, a MA PDU session is established over multiple accesses, and is identified by a unique (or the same) PDU session ID. This is to smoothly support the ATSSS function that can control the transmission of user traffic according to network conditions in the same PDU session.

For example, in a MA PDU session, UP connection 1 may be established through a path including an anchor UPF (PDU Session Anchor, PSA) 340 corresponding to a communication contact point with a DN such as a UE 100, a 3GPP access network 210, a UPF 330, and a server host 410. Meanwhile, in a MA PDU session, UP connection 2 may be established through a path including a UE 100, a non-3GPP access network 220, an N3IVVF 221, a UPF 330, and an anchor UPF (PSA) 340.

For convenience of explanation, although two UPFs are illustrated in FIG. 2, this is for illustrative purpose only, and the scope of the present invention is not limited thereto. For example, in a MA PDU session, there may be an anchor UPF (PSA) 340 only; there may be an anchor UPF (PSA) 340 and one UPF 330; or there may be an anchor UPF (PSA) 340 and two UPFs 330, and so on. That is, configurations of the MA PDU session can be modified in various ways, unlike the configuration illustrated in FIG. 2.

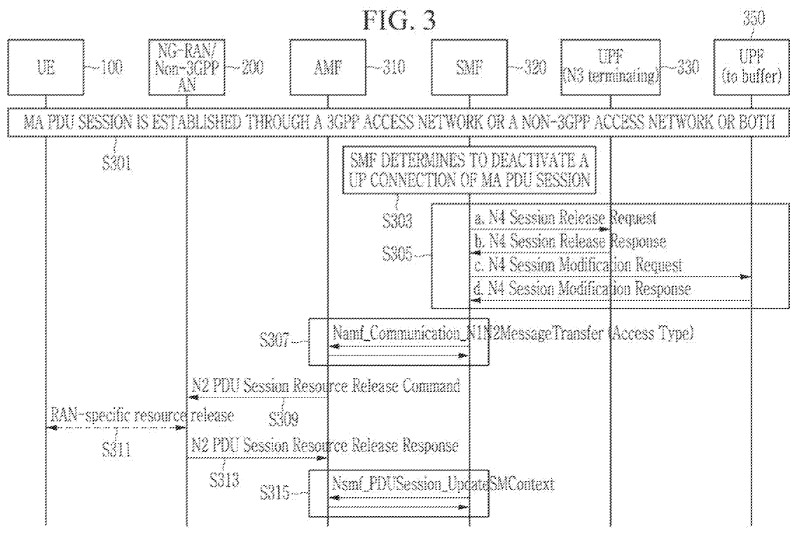

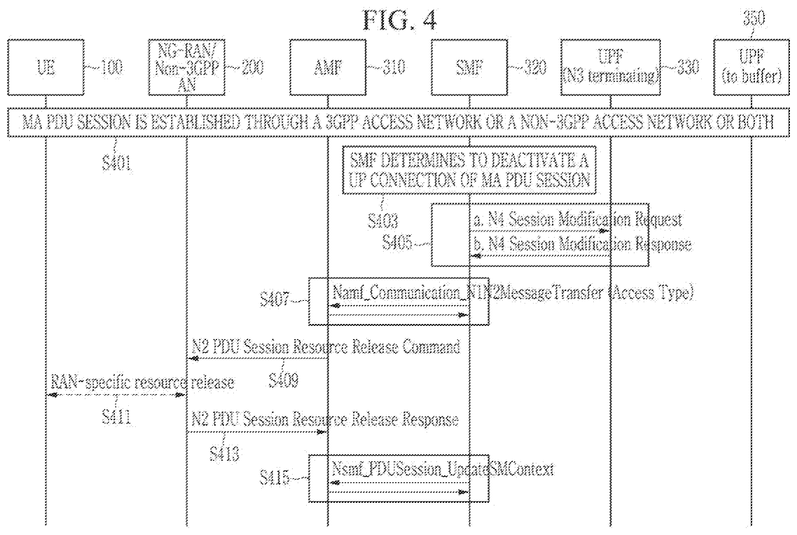

Hereinafter, referring to FIG. 3 and FIG. 4, a method for deactivating one of more UP connections for each access in the MA PDU session individually, that is, when both UP connection 1 and UP connection2 are established, a method for deactivating UP connection 1 or UP connection 2 for each access will be explained.

FIG. 3 is a flowchart illustrating a method for deactivating a UP connection according to an embodiment of the present invention. Referring to FIG. 3, in step S301, a MA PDU session is established through a multi access network, that is, through a 3GPP access network 210 or a non-3GPP access network 220 or both. Specifically, the UE 100 is already registered in the 5G network through the access network 200, and the MA PDU session is established by MA PDU session establishment procedures. The established MA PDU session may have a unique (or the same) PDU session ID. That is, the MA PDU session identified by a unique session ID may be established only through the 3GPP access network 210, or may be established only through the non-3GPP access network 220, or may be established through both the 3GPP access network 210 and the non-3GPP access network 220 simultaneously.

In step S303, the SMF 320 may determine to deactivate a UP connection of the MA PDU session. In particular, for the MA PDU session, the SMF 320 may determine to deactivate a UP connection for a first access network from the multi access network. For example, the multi access network may includes a first access network (e.g., it may be a 3GPP access network 210, but is not limited thereto) and a second access network (e.g., it may be a non-3GPP access network 220, but is not limited thereto), and the SMF 320 may determine to deactivate the UP connection for the first access network.

Certainly, the SMF 320 may determine to deactivate the UP connection for the second access network, or the SMF 320 may determine to deactivate the UP connections for the first access network and the second access network.

Specifically, in addition to the cases triggering the PDU session UP connection deactivation already described in the ATSSS related standards of TS 23.501 and TS 23.502, the SMF 320 may further determine to deactivate the UP connection of the MA PDU session in the following cases.

Case 1: When it is determined that the UP connection of the MA PDU session is unavailable based on a Performance Measurement Function (PMF) access report, the SMF 320 may determine to deactivate the UP connection of the MA PDU session.

Specifically, a PMF access report is a function of determining access availability through a user plane between a UE and a UPF existing in a MA PDU session and notifying the UPF of the determination by the UE. After receiving the determination on the access availability, the UPF may inform the SMF 320 of the necessity of deactivating the UP connection for the access through an N4 reporting procedure. Upon receiving the necessity of deactivating, the SMF 320 may determine to deactivate the UP connection of the MA PDU session.

Case 2: When no data transfer occurs through the UP connection of the MA PDU session for a preset time, the SMF 320 may determine to deactivate the UP connection of the MA PDU session.

Specifically, this is an extension of the case of no data transfer for a specified period in a PDU session established through a single access network, which is one case among the cases triggering the PDU session UP connection deactivation already described in the ATSSS related standards of TS 23.501 and TS 23.502. In the MA PDU session, there are UP connections through a multi access network in one PDU session, thereby when there is no traffic flow for a certain period of time, it may be determined that UP connection deactivation is required for each access, and such determination may be provided to the SMF 320 through the N4 reporting procedure.

As described above, after determining to deactivate the UP connection for the first access network from the multi access network, the SMF 320 sends a message instructing the AMF 310 to deactivate the UP connection for the first access network to the AMF 310, to perform UP connection deactivation. To this end, the SMF 320 may send a message having an access type corresponding to the UP connection that is determined to be deactivated to the AMF 310, where the access type includes at least one of a 3GPP access network and a non-3GPP access network. That is, the access type may include only 3GPP access network, include only non-3GPP access network, or include both 3GPP access network and non-3GPP access network.

On the other hand, for the MA PDU session established through a mufti access network, when it is determined to deactivate the UP connection for the first access network from the multi access network, the AMF 310 may receive a message instructing the AMF 310 to deactivate the UP connection for the first access network, and in response to this, the AMF 310 may perform resource release for the first access network. To this end, the AMF 310 can receive a message having an access type corresponding to the UP connection that is determined to be deactivated from the SMF 320, where the access type includes at least one of a 3GPP access network and a non-3GPP access network. That is, the access type may include only 3GPP access network, include only non-3GPP access network, or include both 3GPP access network and non-3GPP access network.

More details on this will be described with reference to steps 305 to 315.

In step S305, the SMF 320 may determine to release an N3 terminating UPF 330. Then, the SMF 320 may send an N4 Session Release Request message to the N3 terminating UPF 330 through an N4 interface. Then, SMF 320 may receive, in response to the N4 Session Release Request message, an N4 Session Release Response message from UPF 330. Herein, the UPF 330 may release the tunnel and all resources associated with the corresponding N4 session.

Next, the SMF 320 may send an N4 Session Modification Request message to another UPF 350 (an anchor UPF or another Intermediate UPF) connected to the N3 terminating UPF 330. At this time, the SMF 320 may send an N4 Session Modification Request message having access information corresponding to the UP connection determined to be deactivated in step S303 among UP connections in the MA PDU session to another UPF 350 connected to the N3 terminating UPF 330, in response to the N4 Session Modification Request message, an N4 session modification response message from UPF 350. Herein, the access information may mean a (modified) forwarding rule, forwarding information, routing information, and the like for an access.

In step S307, the SMF 320 may send a Namf_Communication_N1N2MessageTransfer message to the AMF 310 through an N11 interface. At this time, the SMF 320 may send a Namf_Communication_N1N2MessageTransfer message having an access type corresponding to the UP connection determined to be deactivated to the AMF 310 and receive a response to the Namf_Communication_N1N2MessageTransfer message from the AMF 310.

In step S309, the AMF 310 may send an N2 PDU Session Resource Release Command message to the access network corresponding to the access type through an N2 interface.

That is, when the access type corresponding to the UP connection determined to be deactivated is a 3GPP access network, the AMF 310 may send an N2 PDU Session Resource Release Command message to the 3GPP access network, when the access type corresponding to the UP connection determined to be deactivated is a non-3GPP access network, the AMF 310 may send an N2 PDU Session Resource Release Command message to the non-3GPP access network, or when the access type corresponding to the UP connection determined to be deactivated has both a 3GPP access network and a non-3GPP access network, the AMF 310 may send N2 PDU Session Resource Release Command messages to both the 3GPP access network and the non-3GPP access network.

In step S311 after the resource for the access network according to the access type corresponding to the UP connection determined to be deactivated is released, in step S313, the AMF 310 may send an N2 PDU Session Resource Release Response message from the access network corresponding to the access type through an N2 interface.

In step S315, the AMF 310 may send a Nsmf_PDUSession_UpdateSMContext message to the SMF 320 through the N11 interface, and receive a response to the Nsmf_PDUSession_UpdateSMContext message from the SMF 320.

As described above, by adding access type indicating the access network included in the establishment of the MA PDU session to the N11 interface, the UP connection can be deactivated for each access within the MA PDU session established through the multi access network.

FIG. 4 is a flowchart illustrating a method for deactivating a UP connection according to another embodiment of the present invention.

Referring to FIG. 4, in step S401, a MA PDU session is established through a multi access network, that is, through a 3GPP access network 210 or a non-3GPP access network 220 or both. That is, the MA PDU session identified by a unique session ID may be established only through the 3GPP access network 210, or may be established only through the non-3GPP access network 220, or may be established through both the 3GPP access network 210 and the non-3GPP access network 220.

In step S403, the SMF 320 may determine to deactivate a UP connection of the MA PDU session. In particular, for the MA PDU session, the SMF 320 may determine to deactivate a UP connection for a first access network from the multi access network, as described above in connection with step S303. Specifically, in addition to the cases triggering the PDU session UP connection deactivation already described in the ATSSS related standards of TS 23.501 and TS 23.502, the SMF 320 may further determine to deactivate the UP connection of the MA PDU session in the following cases.

As described above, after determining to deactivate the UP connection for the first access network from the mufti access network, the SMF 320 sends a message instructing the AMF 310 to deactivate the UP connection for the first access network to the AMF 310, to perform UP connection deactivation. To this end, the SMF 320 may send a message having an access type corresponding to the UP connection that is determined to be deactivated to the AMF 310.

On the other hand, for the MA PDLJ session established through a multi access network, when it is determined to deactivate the UP connection for the first access network from the multi access network, the AMF 310 may receive a message instructing the AMF 310 to deactivate the UP connection for the first access network, and in response to this, the AMF 310 may perform resource release for the first access network. To this end, the AMF 310 can receive a message having an access type corresponding to the UP connection that is determined to be deactivated from the SMF 320.

More details on this will be described with reference to steps 405 to 415.

In step S405, the SMF 320 may determine not to release an N3 terminating UPF 330. Then, the SMF 320 may send an N4 Session Modification Request message to the N3 terminating UPF 330 through an N4 interface.

Accordingly, SMF 320 may send an N4 Session Release Request message having access information corresponding to the UP connection determined to be deactivated in step S403 among UP connections in the MA FDU session to the N3 terminating UPF 330 through the N4 interface and receive, in response to the N4 Session Modification Request message, an N4 session modification response message from UPF 330. Herein, the access information may mean a (modified) forwarding rule, forwarding information, routing information, and the like for an access.

In step 407, the SMF 320 may send a Namf_Communication_N1N2MessageTransfer message to the AMF 310 through an N11 interface. At this time, the SMF 320 may send a Namf_Communication_N1N2MessageTransfer message having an access type corresponding to the UP connection determined to be deactivated to the AMF 310 and receive a response to the Namf_Communication_N1N2MessageTransfer message from the AMF 310.

In step S409, the AMF 310 may send an N2 PDU Session Resource Release Command message to the access network corresponding to the access type through an N2 interface.

That is, when the access type corresponding to the UP connection determined to be deactivated is a 3GPP access network, the AMF 310 may send an N2 PDU Session Resource Release Command message to the 3GPP access network, when the access type corresponding to the UP connection determined to be deactivated is a non-3GPP access network, the AMF 310 may send an N2 PDU Session Resource Release Command message to the non-3GPP access network, or when the access type corresponding to the UP connection determined to be deactivated has both a 3GPP access network and a non-3GPP access network, the AMF 310 may send N2 PDU Session Resource Release Command messages to both the 3GPP access network and the non-3GPP access network.

In step S411, after the resource for the access network according to the access type corresponding to the UP connection determined to be deactivated is released, in step S413, the AMF 310 may send an N2 PDU Session Resource Release Response message from the access network corresponding to the access type through an N2 interface.

In step S415, the AMF 310 may send a Nsmf_PDUSession_UpdateSMContext message to the SMF 320 through the N11 interface, and receive a response to the Nsmf_PDUSession_UpdateSMContext message from the SMF 320.

As described above, by adding access type indicating the access network included in the establishment of the MA PDU session to the N11 interface, the UP connection can be deactivated for each access within the MA PDU session established through the multi access network.

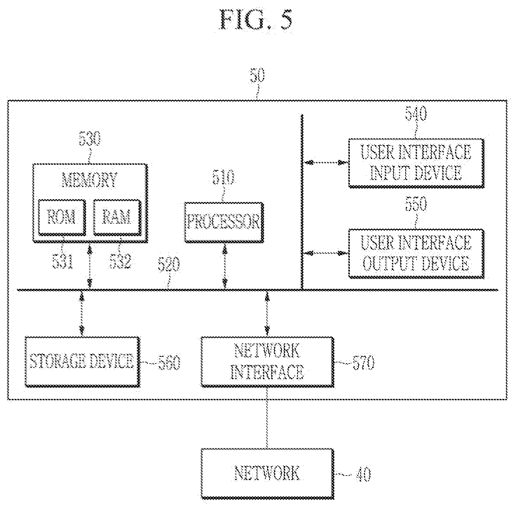

FIG. 5 is a diagram illustrating a computing system according to an embodiment of the present invention.

The computer system 50 of FIG. 5 may be the UE 100, the access network 200, the AMF 310, the SMF 320, the UPF 330, the DN 400, the PCF 500, or the UDM 600 of FIG. 1. The UE 100, the access network 200, the AMF 310, the SMF 320, the UPF 330, the DN 400, the PCF 500, or the UDM 600 may be implemented as a computer system, for example, a computer readable medium.

The computer system 50 includes at least one of a processor 510, a memory 530, a user interface input device 540, a user interface output device 550, and a storage device 560, that communicate via a bus 520. The computer system 50 may also include a network interface 570 coupled to a network 40. The network interface 570 may send or receive signals with other entities over the network 40.

The processor 510 may be a central processing unit (CPU) or any semiconductor device that executes instructions stored in the memory 530 or the storage device 560. The processor 510 may be configured to implement the functions and methods described in FIG. 1 to FIG. 4.

The memory 530 and the storage device 560 may include various types of volatile or non-volatile storage media. For example, the memory 530 may include a read only memory (ROM) 531 and a random access memory (RAM) 532. In embodiments of the present invention, the memory 530 may be located inside or outside the processor 510, and the memory 530 may be connected to the processor 510 through various known means.

Meanwhile, a network entity for controlling a UP connection deactivation in the network may be provided. The network entity includes: a processor configured to, when a MA PDU session is established in an user equipment, control to deactivate a UP connection of the MA PDU session; and a network interface configured to send at least one of an N4 Session Release Request message, an N4 Session Modification Request message, and a Namf_Communication_N1N2MessageTransfer message having an access type corresponding to the UP connection determined to be deactivated, to another network entity, wherein the processor deactivates the UP connection for the access network corresponding to the access type.

Herein, the network interface may send the N4 Session Release Request message or the N4 Session Modification Request message to the N3 terminating UPF through an N4 interface, and refer to the contents described above with reference to FIG. 1 to FIG. 4 for more details.

Meanwhile, herein, the network interface may send the Namf_Communication_N1N2MessageTransfer message to the AMF through an N11 interface, and refer to the contents described above with reference to FIG. to FIG. 4 for more details.

While the present invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for deactivating a UP connection (User Plane connection) in a network, the method comprising:
when a multi access Packet Data Unit session (MA PDU session) is established through a multi access network, determining, by a Session Management Function (SMF), to deactivate a UP connection for a first access network from the multi access network; and
sending, by the SMF, a message instructing an Access and Mobility Management Function (AMF) to deactivate the UP connection for the first access network to the AMF.

2. The method of claim 1, wherein the sending, by the SMF, the message to the AMF comprises:
sending, by the SMF, a message having an access type corresponding to the UP connection determined to be deactivated, and
the access type comprises at least one of a 3GPP access network and a non-3GPP access network.

3. The method of claim 2, wherein the message comprises a Namf_Communication_N1N2MessageTransfer message.

4. The method of claim 3, further comprising:
receiving, by the SMF, a Nsmf_PDUSession_UpdateSMContext message from the AMF in response to the Namf_Communication_N1N2MessageTransfer message.

5. The method of claim 1, wherein the determining, by the SMF, to deactivate the UP connection for the first access network comprises:
when it is determined that the UP connection for the first access network is unavailable based on a Performance Measurement Function (PMF) access report, determining, by the SMF, to deactivate the UP connection for the first access network.

6. The method of claim 1, wherein the determining, by the SMF, to deactivate the UP connection for the first access network comprises:
when no data transfer occurs through the UP connection for the first access network for a preset time, determining, by the SMF, to deactivate the UP connection for the first access network.

7. The method of claim 2, further comprising:
determining, by the SMF, to release an N3 terminating User Plane Function (UPF); and
sending, by the SMF, an N4 Session Release Request message to the N3 terminating UPF.

8. The method of claim 7, further comprising:
sending, by the SMF, an N4 Session Modification Request message having access information to another UPF connected to the N3 terminating UPF.

9. The method of claim 2, further comprising:
determining, by the SMF, not to release an N3 terminating UPF; and
sending, by the SMF, an N4 Session Modification Request message having access information to the N3 terminating UPF.

10. A method for deactivating a UP connection in a network, the method comprising:
for a MA PICU session established through a multi access network, when it is determined to deactivate a UP connection for a first access network from the multi access network, receiving, by an AMF, a message instructing the AMF to deactivate the UP connection for the first access network from a SMF; and
releasing, by the AMF, resources for the first access network.

11. The method of claim 10, wherein the receiving, by the AMF, the message from the SMF comprises:
receiving, by the AMF, a message having an access type corresponding to the UP connection determined to be deactivated from the SMF, and
the access type comprises at least one of a 3GPP access network and a non-3GPP access network.

12. The method of claim 11, wherein the message comprises a Namf_Communication_N1N2MessageTransfer message.

13. The method of claim 10, wherein the releasing, by the AMF, the resources for the first access network comprises:
sending, by the AMF, an N2 PDU Session Resource Release Command message to the first access network.

14. The method of claim 13, further comprising:
receiving, by the AMF, an N2 PDU Session Resource Release Response message from the first access network.

15. the method of claim 14, further comprising:
sending, by the AMF, a Nsmf_PDUSession_UpdateSMContext message to the SMF.

16. The method of claim 10, wherein the receiving, by the AMF, the message from the SMF comprises:
when it is determined that the UP connection for the first access network is unavailable based on a PMF access report, receiving, by the AMF, the message instructing the AMF to deactivate the UP connection for the first access network from the SMF.

17. The method of Tim 10, wherein the receiving, by the AMF, the message from the SMF comprises:
when no data transfer occurs through the UP connection for the first access network for a preset time, receiving, by the AMF, the message instructing the AMF to deactivate the UP connection for the first access network from the SMF.

18. A network entity for controlling a UP connection deactivation in the network, the network entity comprising:
a processor configured to, when a MA PDU session is established in an user equipment, control to deactivate a UP connection of the MA PDU session; and
a network interface configured to send at least one of an N4 Session Release Request message, an N4 Session Modification Request message, and a Namf_Communication_N1N2MessageTransfer message having an access type corresponding to the UP connection determined to be deactivated, to another network entity,
wherein the processor deactivates the UP connection for the access network corresponding to the access type.

19. The network entity of claim 18, wherein the network interface sends the N4 Session Release Request message or the N4 Session Modification Request message to the N3 terminating UPF through an N4 interface.

20. The network entity of claim 18, wherein the network interface sends the Namf_Communication_N1N2MessageTransfer message to the AMF through an N11 interface.
